(19) United States
(12) Patent Application Publication
(10) Pub. No.: US 2021/0322797 A1
(43) Pub. Date: Oct. 21, 2021

(54) REUSABLE BREATHING MASK USING DISPOSABLE RECYCLABLE FLEXIBLE MATERIALS

(71) Applicant: KING ABDULLAH UNIVERSITY OF SCIENCE AND TECHNOLOGY, Thuwal (SA)

(72) Inventors: Muhammad Mustafa HUSSAIN, Hercules, CA (US); Nazek Mohamad EL-ATAB, Thuwal (SA); Wedyan BABATAIN, Thuwal (SA)

(21) Appl. No.: 17/233,792

(22) Filed: Apr. 19, 2021

Related U.S. Application Data
(60) Provisional application No. 63/047,508, filed on Jul. 2, 2020.
(60) Provisional application No. 63/013,193, filed on Apr. 21, 2020.

(51) Int. Cl. A62B 7/10; A62B 9/00; A62B 23/02; A41D 13/11; B01D 46/54; B01D 46/42; B01D 46/00

(52) U.S. Cl. CPC A62B 7/10; A62B 9/00; A62B 23/025; A41D 13/1107; B01D 46/543; B01D 46/546; B01D 2265/02; B01D 46/0032; B01D 46/4245; B01D 46/008; B01D 46/0001; B01D 2279/40; B01D 46/429

(57) ABSTRACT

A breathing mask for being worn on the face includes a filtration mechanism configured to filter out particles having a diameter larger than a first predetermined value; a connecting mechanism; and a removable nano-porous hydrophobic membrane configured to be removably attached to the filtration mechanism with the connecting mechanism. The nano-porous membrane is configured to filter out particles having a diameter larger than a second predetermined value, which is different from the first predetermined value.

### CROSS-REFERENCE TO RELATED APPLICATIONS

This application claims priority to U.S. Provisional Patent Application No. 63/013,193, filed on Apr. 21, 2021, entitled “REUSABLE N-95 MASKS USING DISPOSABLE RECYCLABLE FLEXIBLE MATERIALS,” and U.S. Provisional Patent Application No. 63/047,508, filed on Jul. 2, 2020, entitled “REUSABLE BREATHING MASK USING DISPOSABLE RECYCLABLE FLEXIBLE MATERIALS,” the disclosures of which are incorporated herein by reference in their entirety.

### BACKGROUND

### Technical Field

Embodiments of the subject matter disclosed herein generally relate to breathing face masks, and more particularly, to a N95 mask that is made reusable by using a flexible, disposable material that is removably attached over the mask.

### Discussion of the Background

In December 2019, an outbreak of a severe respiratory disease due to the novel coronavirus (COVID-19) started in China, and then rapidly spread around the world. As of May 9, 2020, the COVID-19 virus has been confirmed in 4,080,426 people worldwide with 279,286 deaths. The disease is extremely infectious, with infected people mainly experiencing fatigue, dry cough, and fever, although a large percentage of the carriers remain asymptomatic. Virus transmission is believed to take place via respiratory droplets resulting from sneezing and coughing.

Respiratory droplets exist in different sizes, where aerosols specifically consist of droplets that are sub-5 μm in size. Droplets that are larger than 5 μm generally do not travel long distances and settle within 1-2 m as a result of the gravitational force. However, the aerosols are smaller and lighter and therefore they can remain floating in the air for extended periods of time, which can severely increase the spread of the virus. Thus, the use of facial masks provides a physical barrier that reduce exposure to these infectious droplets.

Unprecedented measures have been taken globally to stop the rapid spread of this ongoing pandemic, including travel restrictions, remote working, and homeschooling. Moreover, wearing masks when going out in public became necessary and obligatory in some regions to reduce the transmission and contamination rate. As a result, demand for single-use surgical masks escalated dramatically. The sudden increase in the demand for such face masks led to their shortage in the market and the inability of the manufacturers to meet the demands. Consequently, several countries have placed limitations on the maximum number of masks a person can buy during a specific period. In addition, it was suggested that the protective masks should be reserved for workers in the health sector who are at higher risk.

Although several types of commercial face masks can provide different levels of protection, the surgical grade N95 masks are found to be the most efficient masks so far. However, this mask is expensive, in limited supply, and its filtration efficiency for particles with sizes smaller than 300 nm is around 85% due to the larger pore size in the filter layer (˜300 nm). Moreover, the COVID-19 virus has been shown to belong to the beta-COVs category with an elliptic or spherical shape and size in the range of 65-125 nm, which confirms the need for the development of more efficient filtration masks.

In general, air filters can be divided into two main categories: depth filters and membranes. Depth filters are usually based on cellulose, glass fibers, or glass wool, and the filtering mechanism is based on either impaction, interception, diffusion, sedimentation, or electrostatic attraction. Depth filters achieve air stabilization by retaining the particles within them rather than on their surface. In contrast, membrane-based filters consist of a thin and porous polymeric film, and the filtration mechanism is based on straining. In this case, the size of the pores is smaller than the size of the particles, causing their filtration. Nevertheless, one issue that arises in such filters is cake formation in which filtered particles accumulate on the surface of the membrane and then block and limit the passage of additional filtrate through the membrane. As a result, an antifouling mechanism is needed to clean the filter in this case.

Thus, there is a need for making the N95 masks more accessible to the public, in a short time, and without increasing the price of these masks. Also there is a need to make these masks even more efficient.

### BRIEF SUMMARY OF THE INVENTION

According to an embodiment, there is a breathing mask for being worn on the face, and the breathing mask includes a filtration mechanism configured to filter out particles having a diameter larger than a first predetermined value, a connecting mechanism, and a removable nano-porous hydrophobic membrane configured to be removably attached to the filtration mechanism with the connecting mechanism. The nano-porous membrane is configured to filter out particles having a diameter larger than a second predetermined value, which is different from the first predetermined value.

According to another embodiment, there is a method for replacing a nano-porous membrane of a breathing mask that is being worn on the face, and the method includes removing the nano-porous membrane from the mask, wherein the nano-porous membrane is removably attached to a filtration mechanism with a connecting mechanism; and placing a new nano-porous membrane over the filtration mechanism. The filtration mechanism is configured to filter out particles having a diameter larger than a first predetermined value, and the nano-porous membrane is configured to filter out particles having a diameter larger than a second predetermined value, which is different from the first predetermined value.

According to still another embodiment, there is a method for manufacturing a nano-porous membrane to be used with a breathing mask. The method includes providing a membrane and making nano-holes into the membrane to obtain a nano-porous membrane, wherein the nano-porous membrane is configured to filter out particles having a diameter larger than a first predetermined value. The breathing mask has a filtration mechanism configured to filter out particles having a diameter larger than a second predetermined value, which is different from the first predetermined value.

### BRIEF DESCRIPTION OF THE DRAWINGS

For a more complete understanding of the present invention, reference is now made to the following descriptions taken in conjunction with the accompanying drawings, in which:

FIG. 1A is a schematic diagram of a membrane and a hole making tool that makes holes into the membrane to obtain a nano-porous membrane, FIG. 1B shows the nano-porous membrane with plural holes, and FIG. 1C shows the holes being reduced in size to become nano-holes;

FIGS. 2A to 2D illustrate a breathing mask having a removable nano-porous hydrophobic membrane;

FIGS. 3A and 3B show how to make a hole making tool with nano-sized needles;

FIG. 4 shows another hole making tool having nano-sized needles;

FIG. 5 illustrates a mesh of nanowires that is used as a mask for making nano-holes into a membrane;

FIG. 6 shows a mesh of nanowires that is pressed between two porous materials to form a nano-porous membrane;

FIGS. 7A to 7G illustrate how to make a hole making tool with nano-sized needles;

FIGS. 8A to 8E illustrate how to make a porous template for manufacturing a nano-porous membrane;

FIGS. 9A to 9E show how to use the porous template to make the nano-porous hydrophobic membrane;

FIGS. 10A and 10B illustrate the influence of the pore size in the nano-porous membrane on the airflow rate through the mask;

FIGS. 11A and 11B illustrate the influence of the mask thickness and the pressure drop on the airflow rate through the mask; and

FIG. 12 is a flowchart of a method for replacing a nano-porous membrane of a mask configured to cover the face.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a traditional N95 face mask. However, the embodiments to be discussed next are not limited to such a mask, but may be applied to other masks or air filtration systems.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a nano-porous membrane (for example, down to 5 nm pores) is manufactured and then attached on an existing N95 mask and replaced after every use or after a set time. The membrane can be either intrinsically hydrophobic or made hydrophobic via a post-processing treatment. In this way, the N95 mask, which is originally manufactured to be of single use, can be reused a couple of times due to the clean nano-porous membrane that is placed over the mask. The nano-porous membrane may be made with various materials and methods. In one embodiment, the nano-porous membrane is based on a naturally hydrophobic polymer such that the droplets that come into contact with the mask will roll and slide over the mask due to the large inclination angle of the membrane when worn on the face mask. The membrane may be developed by (1) using a shrinkable porous polystyrene film that is punctured with plural microneedles, or metallic nanowires, (2) using a dense paper or fabric material that is punctured with the plural microneedles, or metallic nanowires, (3) using a mesh of nanowires that are coated by atomic layer deposition (ALD) to control a size of the pores, (4) sandwiching a mesh of nanowires between porous paper or fabric layers, or (5) fabricating a Si-based nano-porous template via patterning and potassium hydroxide (KOH) etching of either a silicon wafer or a wafer having a silicon layer bonded to an insulator layer, or a completely different material than silicon which would be etched using a different chemical/process than KOH, and then the released porous template is used as a hard mask to transfer the patterns onto an ultrathin and hydrophobic polymeric film via reactive ion etching (RIE). If the last method is used, the porous template can be reused to develop multiple nano-porous membranes. In addition, the template can be reused on the same membrane following a “step-and-repeat” process to increase its porosity. The results show that nanopores with sizes down to 5 nm can be achieved with a narrow distribution. In one embodiment, the pore made in the membrane have a diameter of about 50 nm, where the term “about” is understood herein to mean +/−20%.

The inventors performed theoretical calculations to assess the breathability of the obtained membrane and found that airflow rates above 85 L/min can be obtained. The inventors also analyzed the effects of the pore size, density, membrane thickness, and pressure drop on the breathability of the mask. Thus, the proposed solution would assist one to develop nano-porous membranes that could be attached on top of an N95 mask to provide enhanced protection against the COVID-19 virus. After every use, the membrane would be removed and replaced with a new one while the same N-95 mask would be reused, as now discussed in more detail.

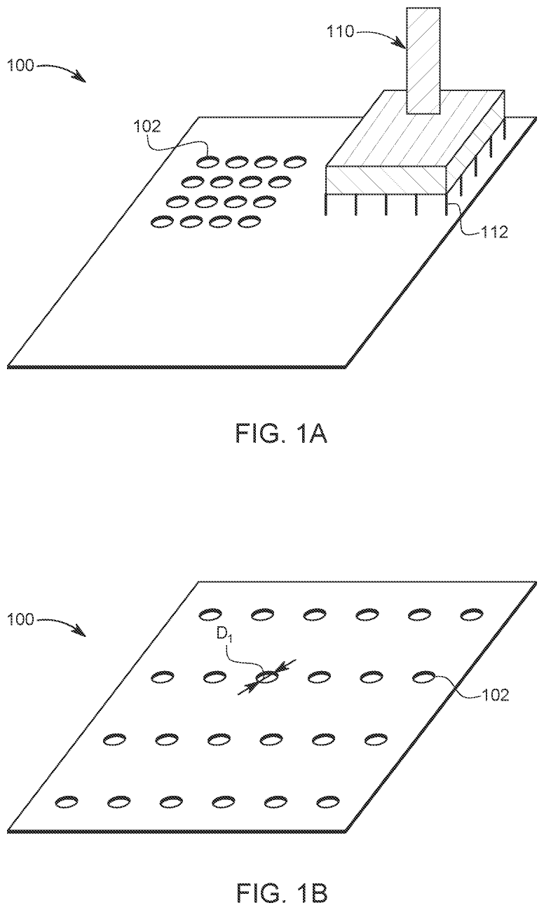

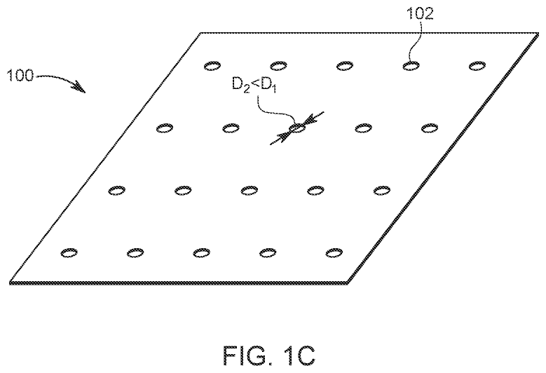

According to an embodiment illustrated in FIG. 1A, a shrinkable film 100 (for example, made of polystyrene) is punctured with a commercial tool 110 that has a plurality of microneedles 112, for forming corresponding holes 102 into the flexible film. The shrinkable polymer can be either intrinsically hydrophobic or made hydrophobic using a post-processing treatment. In one application, the tips of the microneedles 112 have a diameter of 1 to 10 μm. Other diameters may be used depending on the desired size of the nanopores in the film 100. After the entire film 100 is punctured with the tool 110, as shown in FIG. 1B, the film 100 is placed in an oven, for example, at 300° C. for 2 minutes (or at 160° C. for 5 minutes), to shrink the diameter D1 of the holes 102 to a smaller diameter D2, to obtain a nano-porous membrane 200, as shown in FIG. 1C. Depending on the temperature and the time in the oven, the diameter of the holes 102 and the spacing between them can be shrank up to 95%. For the temperature and time noted above, the initial diameter D1 between 1 and 10 μm of the holes 102 is reduced to a diameter D2 between 50 and 500 nm.

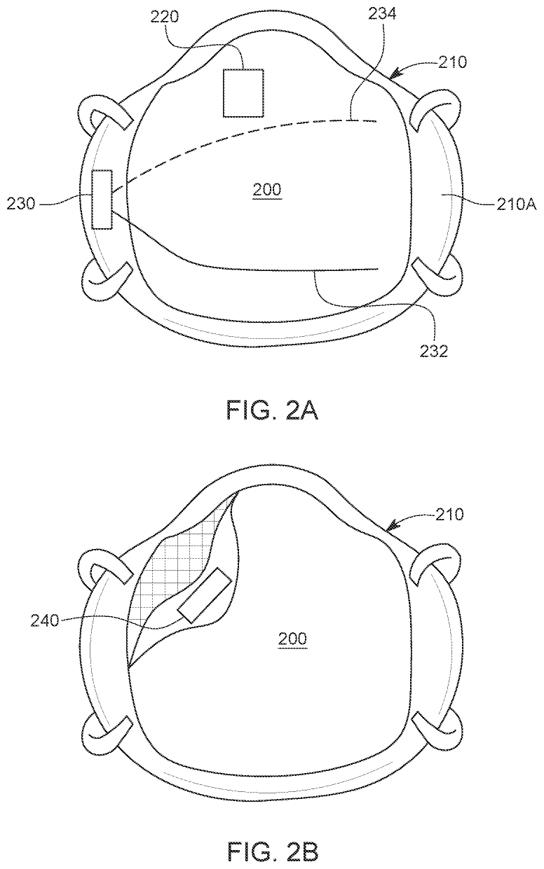

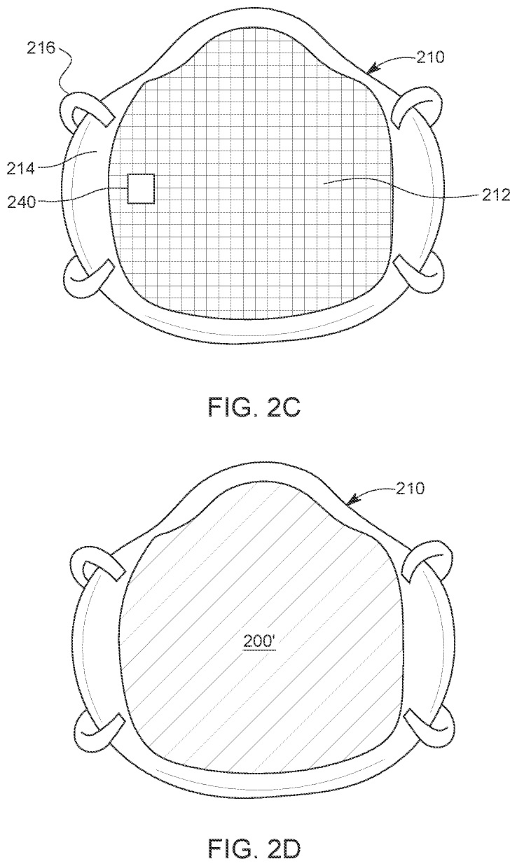

The nano-porous membrane 200 is then cut into small nano-porous patches, which are attached to the exterior face of a given N95 mask. More specifically, as shown in FIG. 2A, the nano-porous membrane 200 is shaped to fit over an existing N95 mask 210. The nano-porous membrane 200 is attached over the external surface 210A of the N95 mask 210 with any known means, for example, glue, or a Velcro-connector, or similar elements. The membrane 200 may include a sensor 220, and a power source 230 may be attached to the mask, and these elements are discussed later. The power source may be connected to two or more terminals 232 and 234, which are also discussed later.

After the nano-porous membrane 200 has been used for a given time on the mask 210, for example, 8 h but other times are also possible, the user can start to peel off the nano-porous membrane 200 as shown in FIG. 2B, until the entire nano-porous membrane 200 is completely removed from the mask 210, as shown in FIG. 2C. FIG. 2C shows the original filtrating mechanism 212 of the N95 mask 210. The filtrating mechanism 212 is made from one or more layers of a nano-porous material (e.g., paper, fabric, polymer, etc.) and these layers are connected to each other at the periphery 214 of the mask 210. One or more bands 216 are attached to the periphery 214, for fixing the mask to the head of the user. After the filtrating mechanism 212 becomes contaminated, the entire mask 210 is compromised and needs to be disposed. However, the filtrating mechanism 212's lifetime may be increased by adding the nano-porous membrane 200, which ensures the filtration function and prevents contamination of the filtrating mechanism 212. In addition, the nano-porous membrane 200 may have a filtration capability superior to that of the original mask 210, thus enhancing the overall filtration of the mask. For example, the N95 mask is designed to remove/filter out particles having a diameter larger than 300 nm, while the membrane 200 may be manufactured to remove particles having a diameter of 50 nm or 100 nm or larger.

To continue to use the N95 mask, the user can place a brand new nano-porous membrane 200′ over the filtration mechanism 212, as illustrated in FIG. 2D. Either the original filtration mechanism 212 or the membrane 200, 200′ or both, may be provided with one or more connecting mechanisms 240 (see FIGS. 2B and 2C), for enhancing the natural connection between the membrane 200 and the filtration mechanism 212. In one application, the connecting mechanism 240 includes a hook-and-loop fastener, e.g., a Velcro strip type connection. In another embodiment, the connecting mechanism 240 includes a drop of a glue. Other fasteners may be used. Thus, the wearer can use the N95 mask for another 8 hours. At the end of the lifetime of the nano-porous membrane 200 (which was assumed to be 8 hours, but it can be less or more), the user may again replace the nano-porous membrane 200 with another one, so that the original N95 mask 210 becomes a reusable mask, instead of being a disposable mask.

In this way, when restrictions are in place in terms of the number of masks that a user can buy in a given county, that person can extend the lifetime of the original N95 mask with the use of the nano-porous membrane 200. Note that the nano-porous membrane 200 can be attached to any existing mask without any modification of the mask, which is very advantageous. The nano-porous hydrophobic membrane 200 may be manufactured to have an ordered array of holes, it can be manufactured to have control over the density of the holes over the film and the size of the holes, the fabrication process allows for a rapid implementation and scaling up in an industrial setting, and the materials and tools necessary to manufacture the nano-porous membrane 200 are readily available, as now discussed.

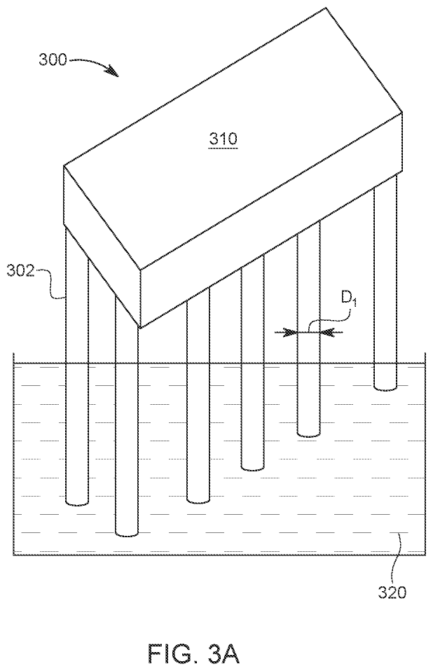

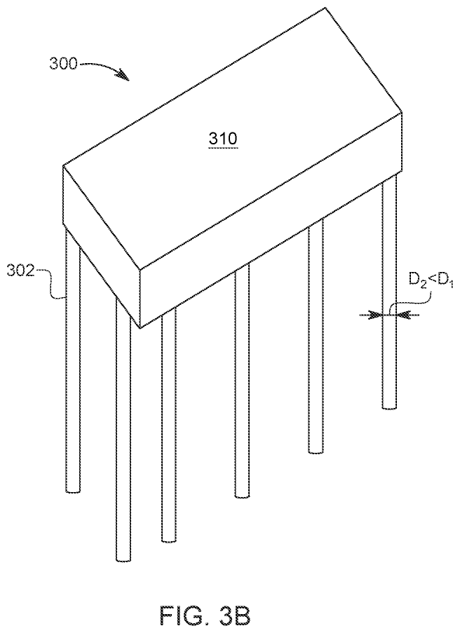

The nano-porous membrane may be made from various materials, for example, paper or fabric, instead of a polymeric material. A post-processing treatment can be applied to turn the membrane surface into a hydrophobic one. For this situation, the hole making tool used to make the holes into the nano-porous membrane may have plural metallic nanowires. In one application, a hole making tool 300 may be made as follows. Plural μm-thick metallic wires 302 (which are a few cm long) may be connected (e.g., glued) to a holder 310, as shown in FIG. 3A, to achieve an array of metallic wires. Then, the μm-thick wires 302 are placed into an etchant solution 320 to attack the metallic material of the wires 302, to reduce their initial micrometer diameter D1 to a nano size diameter D2, as shown in FIG. 3B. In one application, the wires are made out of copper, the etchant is a copper etchant, and the holder is made of a polymeric material, e.g., polydimethylsiloxane (PDMS). In this application, the wires may be spaced apart by about 5 mm. Other distances may be used. The final diameter D2 of the wires may be about 100 nm or less. In one application, the final diameter D2 is about 50 nm or even 5 nm. In this embodiment, the number of holes and their distribution over the nano-porous membrane 200 may be controlled by the way the metallic wires 302 are added to the holder 310, and the materials necessary for making the tool 300 and the nano-porous membrane 200 are readily available.

If more sophisticated manufacturing equipment is available, a more precise hole making tool 400 may be made as now discussed with regard to FIG. 4. On a Si-substrate 402, nanometer gold particles 404 are coated to form a seed layer. Then, nanowires 406 are grown over the gold nanoparticles 404, using for example, a plasma-enhanced chemical vapor deposition (PECVD) method. The nanowires 406 would act as nano-needles to puncture the dense paper or fabric material from which the nano-porous membrane 200 is made. An advantage of this method is the small diameter of the nanowires 406, and the large surface of the substrate 402.

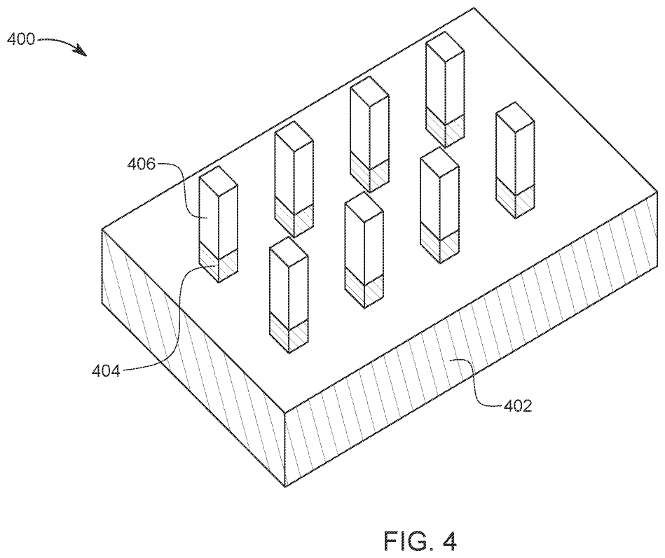

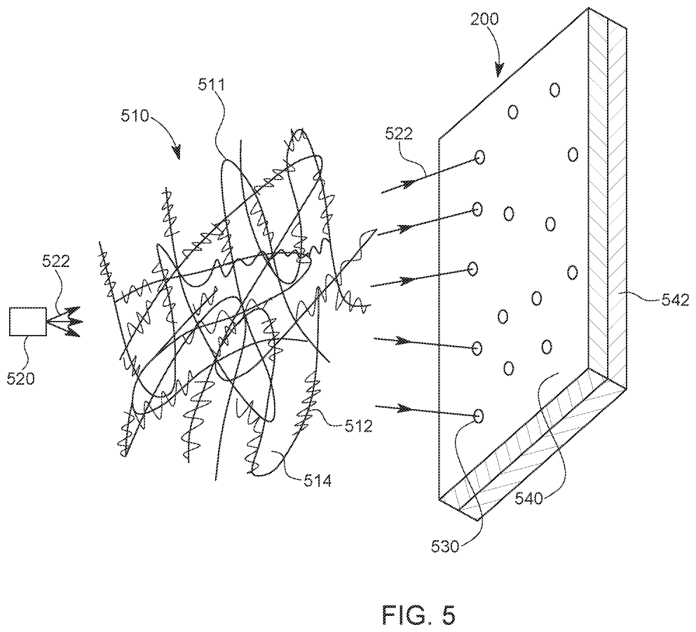

In another embodiment, as illustrated in FIG. 5, a mesh 510 of nanowires 511 may be coated with a material 512, through the ALD method, to reduce the pore 514 size under 100 nm. Then, the mesh 510 is used as a mask during laser exposure to a laser beam 522 from a laser 520, to form corresponding holes 530 into a polymeric layer 540, to achieve the nano-porous membrane 200. The membrane 200 is then cut to fit the external surface of a N95 mask, as previously discussed. The nanowires 511 in this embodiment may be made based on Si or ZnO, the laser may be a CO₂ laser, and the polymeric material of the substrate 540 may include PDMS or polyimide (PI). Thus, in this embodiment, the nano-porous membrane may be made with no needles, and the diameter of the holes 530 may be controlled to be under 100 nm, for example 50 nm or 5 nm. The holes 530, which correspond to the pores 514, are randomly distributed over the polymeric layer 540. In one embodiment, the polymeric layer 540 is coating a Si substrate 542.

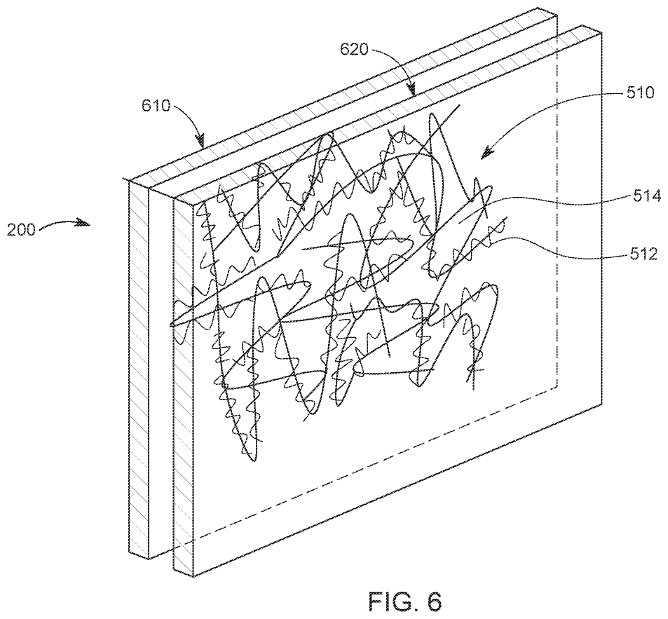

The mesh 510 of nanowires 511, coated with the material 512, may also be used as is to form the nano-porous membrane 200. For example, as illustrated in FIG. 6, the mesh 510 of nanowires 511 may be sandwiched between two porous layers 610 and 620 (e.g., porous paper or fabric) to form the membrane 200. The mesh 510 of nanowires may be coated with the material 512 to reduce the size of the pores 514, as previously discussed with regard to FIG. 5.

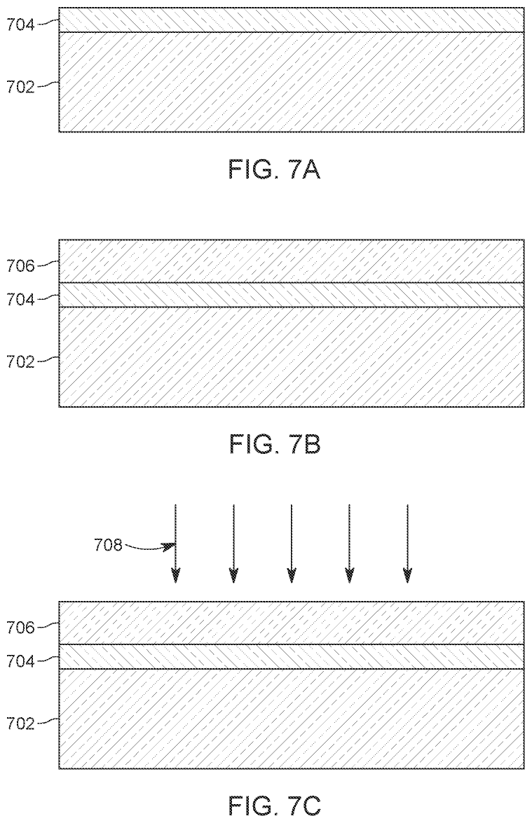

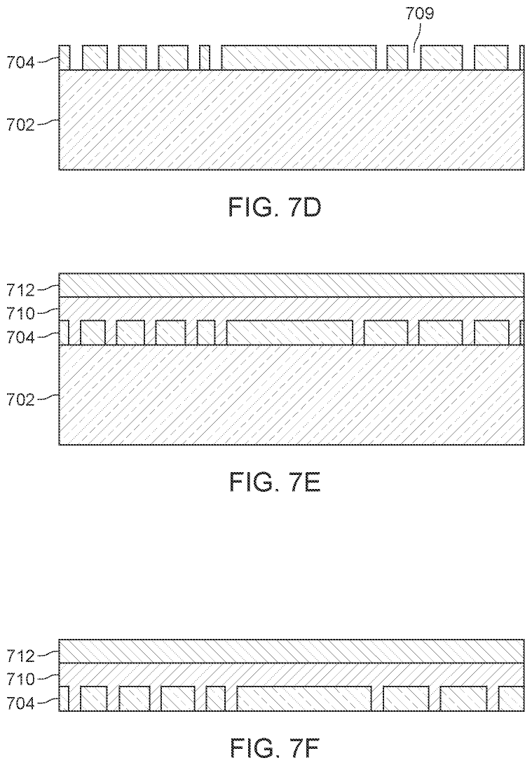

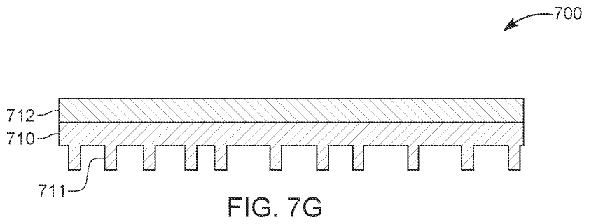

Another way for obtaining a hole making tool 700 for manufacturing the nano-porous membrane 200 is now discussed with regard to FIGS. 7A to 7G. FIG. 7A shows a substrate 702 that is coated with a first polymer layer 704. The substrate 702 may be made of Si and the first polymer layer 704 may be made of PI. In one embodiment, the substrate 702 may be first coated with gold, to make the removal at a later stage of the first polymer layer 704 easier. Then, a mesh 706 of nanowires (made, for example, of Si or ZnO) having nanogaps is placed over the first polymer layer 704 as shown in FIG. 7B, and the mesh of nanowires acts as a mask, as shown in FIG. 7C, when a laser beam 708 is irradiated through the mesh 706 to remove desired portions from the first polymer layer 704. FIG. 7D shows a pattern formed into the first polymer layer 704, after the mesh 706 of nanowires has been removed. Note that the holes or grooves 709 formed into the first polymer layer 704 have a size less than 100 nm, e.g., around 50 nm or around 5 nm, due to the small size of the pores of the mesh 706 of nanowires. Then, a layer 710 of platinum (Pt) is deposited, using, for example, the ALD method, over the first polymer layer 704 and also over the substrate 702, in the holes 709 made in the first polymer layer 704, as illustrated in FIG. 7E. A second polymer layer 712 is then spin coated over the Pt layer 710, as also illustrated in FIG. 7E. The second polymer layer 712 may include PDMS. Then, as shown in FIG. 7F, the two polymer layers 704 and 712 together with the Pt layer 710 are peeled off from the substrate 702 and the first polymer layer 704 is etched out to expose the needles 711 of the Pt layer 710. In this way, the hole making tool 700 is achieved, as shown in FIG. 7G. Note that the needles 711 have a size below 100 nm because the holes 709 were designed to have such a nano size. This tool can now be used, as discussed in the previous embodiments, to make nano-holes into a selected membrane to obtain the nano-porous membrane 200.

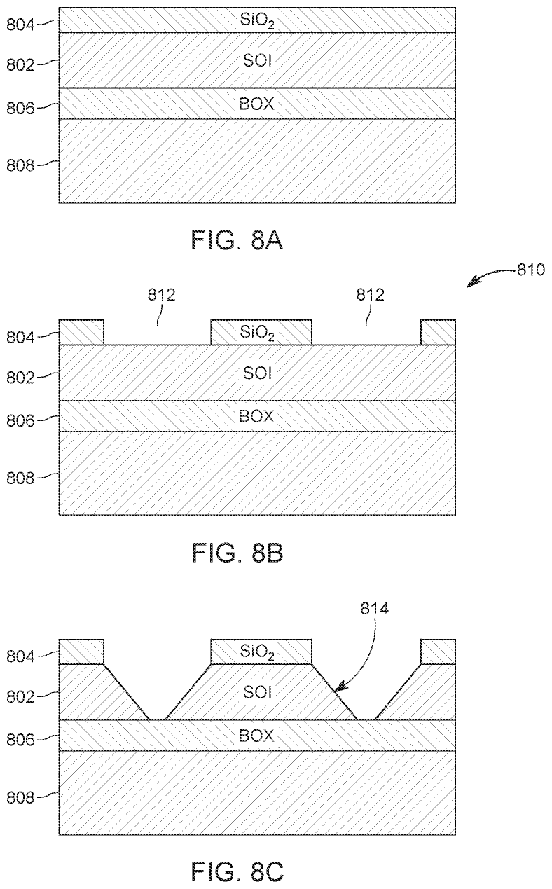

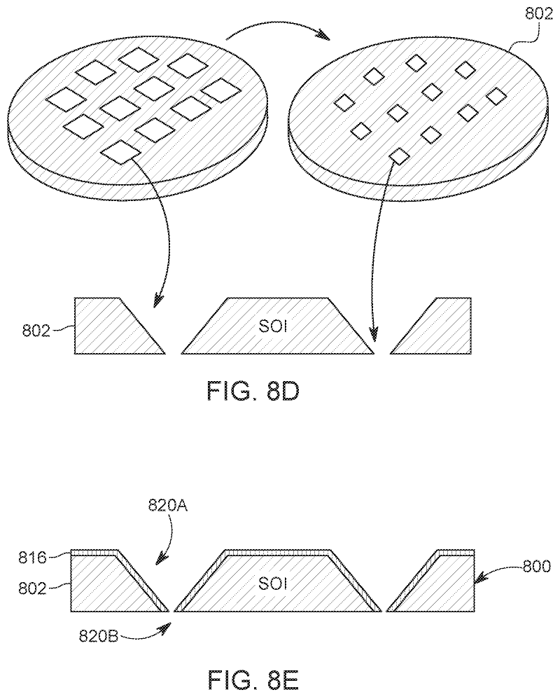

According to still another embodiment, it is possible to manufacture the nano-porous membrane 200 based on a Si-based porous template. More specifically, as illustrated in FIGS. 8A to 8E, either a wafer 802 having silicon bonded to a different material, or just a pure silicon wafer, or even a different material than silicon which requires a different etchant than KOH, may be used. In one embodiment, this includes a 77 nm thick active silicon, which is coated with a 15 nm thick SiO₂ hard mask 804, as illustrated in FIG. 8A. This figure also shows a buried oxide (BOX) insulating layer 806 on which the silicon on insulator (SOI) layer 802 is formed. The BOX layer 806 may be formed on a substrate 808. The SOI layer 802 is patterned using e-beam lithography, or a different nano-lithography technique, such that an array 810 of 90 nm by 90 nm squares 812 is obtained, as shown in FIG. 8B. The spacing between the squares 812 is initially fixed at 200 nm to avoid the proximity effect. Next, as illustrated in FIG. 8C, a RIE method is used to remove some of the SOI 802 in the exposed areas, whereas the KOH method is used to achieve the V-grooves 814. KOH etches the Si layer preferentially in the (100) plane, leaving behind the V-grooves 814 with sidewalls that form an angle of about 54.7° with the surface. The final size of the apertures/pores is thus a function of the patterned square features 812, the thickness of the SOI 802, and the KOH etch time.

Therefore, the photolithography could be used to pattern larger squares (in the micrometer range) when the initial thickness of the SOI is thicker (in the micrometer range). The SOI layer 802 is then released by etching the BOX layer 806 using vapor HF, as depicted in FIG. 8D. Then, the porous template 800 is coated with a sputtered layer 816 of copper, as shown in FIG. 8E, to enhance its mechanical resilience and its etch selectivity when used as a hard mask in the development of the nano-porous membranes. Note that the V-grooves 814 make the porous template 800 to have larger holes 820A one side than the holes 820B on the other side.

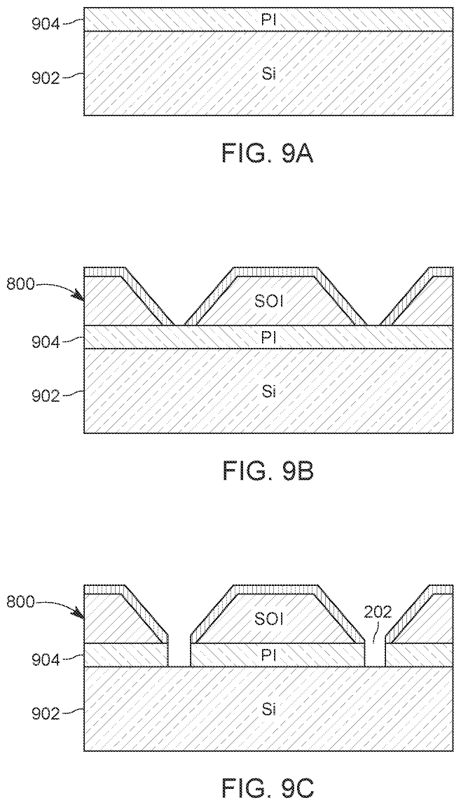

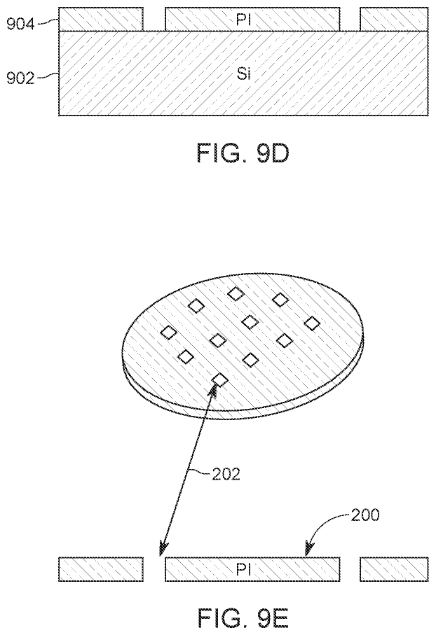

The porous template 800 is then used to manufacture the nano-porous membrane 200 as now discussed with regard to FIGS. 9A to 9E. FIG. 9A shows a Si(100) wafer 902 with a SiO₂ top, which is thermally grown, and a 10 μm polyimide (PI) film 904 spin-coated and cured on top of the SiO₂ layer. The SiO₂ layer has a lower bonding energy with the PI layer than that with Si, which means that is easier to peel off the membrane from the Si substrate. The nano-porous template 800, previously discussed with regard to FIG. 8E, is then physically secured on top of the PI film 904, as shown in FIG. 9B, and employed as a hard mask during the PI plasma etching in an RIE system in order to transfer the nanopatterns onto the polymeric film 904. After the plasma etching process, which makes nanopores 202 into the PI film 904, as shown in FIG. 9C, the template 800 is removed as shown in FIG. 9D and the PI film 904 is peeled off from the substrate 902, to obtain the nano-porous membrane 200, as shown in FIG. 9E. The nano-porous membrane 200 can now be attached onto an N95 mask as discussed above with regard to FIGS. 2A to 2D. The PI-based membrane 200, having the same size as the N95 mask 210, is ultralightweight, e.g., it has a weight of less than 0.12 g. Different materials than PI can be used. The materials can be either intrinsically hydrophobic or made hydrophobic using a post-processing treatment.

The pore sizes of the template 800 obtained with the method illustrated in FIGS. 8A to 8E were characterized, after etching in KOH for different durations, using scanning electron microscopy (SEM). The pore size ranges from 5 nm to 55 nm when the etching time is between 12 s to 23 s. The distribution of the pore sizes is narrow (˜5 nm), which makes it efficient in the application as a hard mask during membrane 200 development. When the template 800 is used to make the nano-porous membrane 200, the spacing between the nanopores 202 is larger than the spacing between the patterned squares 812 as a result of the etching profile following the V-grooves 814 (see FIG. 8C). With a 200 nm spacing between the 90 nm by 90 nm patterned squares 812, the resulting spacing between 10 nm pores 202 is 280 nm, whereas the resulting spacing between 50 nm pores 202 is 240 nm. Nevertheless, the density of pores 202 or porosity of the membrane 200 can be improved by performing multiple patterning steps with the hard mask 800 using a step-and-repeat process.

Turning to the efficiency of the nano-porous membrane 200 manufactured with any one of the methods discussed with regard to FIGS. 3A to 9E, several aerosol filtration mechanisms exist, including gravity sedimentation, interception, impingement, diffusion, and electrostatic attraction. Generally, large droplets having dimensions in the range of 1-10 μm experience gravity sedimentation or impingement. For smaller droplets (aerosols), the electrostatic attraction becomes the most efficient filtering mechanism, where charged fibers attract the fine particles and get attached to them. Nevertheless, these mechanisms take place in depth filters consisting of a mesh of fibers where the pore sizes are always larger than the fine particle sizes.

Thus, air velocity plays a key role in the efficiency of the filter, with higher velocities reducing the filtration efficiency. However, the proposed nano-porous membrane 200 is based on a membrane where the main filtering mechanism is straining. In this case, filtration occurs because the size of the pores 202 is smaller than the size of the particles, so the efficiency of the membrane as a filter does not depend on the air velocity. Therefore, in one embodiment, it is possible to customize the pore dimensions of the membrane based on the particles to be removed, for instance, the pore size should be below 60 nm if the droplet containing the COVID-19 virus has a size >60 nm. In one application, the pores of the nano-porous membrane are made to be 50 nm or larger or 5 nm or larger.

Even though the filtration efficiency of straining-based membranes is not affected by the airflow rate through it, the airflow rate does have an impact on the breathability of the mask. According to the United States National Institute for Occupational Safety and Health (NIOSH), the airflow rate through a mask should be larger than 85 L/min, which corresponds to a moderately high work rate. In addition, according to NIOSH, a certified N95 mask should not show a pressure drop above 343.2 Pa during inhalation and 245.1 Pa during exhalation, when tested using an airflow rate of 85 L/min. A higher pressure drop means that a higher airflow resistance would be experienced, which degrades the breathability of the mask.

Therefore, to assess the performance of the membrane 200, the airflow rate through the pores 202, assuming a maximum pressure drop of 345 Pa, was calculated as now discussed. To simply the calculations, it was assumed that the shape of the pore is circular, as the pore size is in the nanoscale range. Moreover, it was assumed that the flow is laminar with negligible effects of friction. The air mean velocity Uₘ was estimated using Equation 1, and the airflow rate Q was determined using Equation 2 as follow:

$$\begin{matrix}{U}_{m} = \frac{Δ P {d}_{p}^{2}}{32 h η} , & ( 1 ) \\ Q = m A {U}_{m} , & ( 2 )\end{matrix}$$

where Uₘ is the air mean velocity (m/s), dₚ is the pore 202 diameter (m), ΔP is the pressure gradient across the mask (Pa), h is the pore length (m), η is the dynamic viscosity of air (Pas), m is the number of pores, A is the area of the mask (m²), and Q is the volumetric flow rate of air through the pores (m³/s).

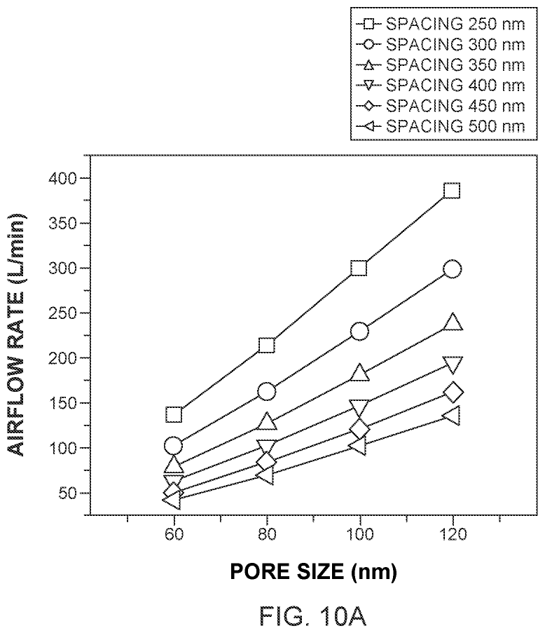

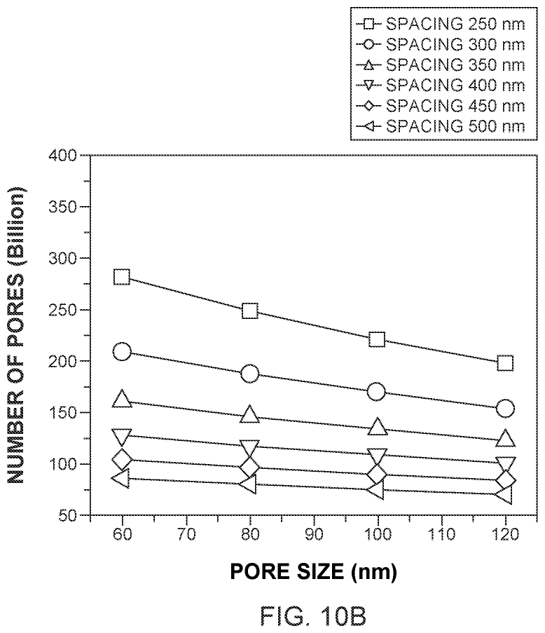

The results of the tests of the membrane 200 show that as the size of the pores 202 is increased for the same spacing or when the spacing between the pores is reduced, the airflow rate is increased, meaning that the breathability of the membrane 200 is enhanced due to the enhanced porosity of the membrane, as illustrated in FIG. 10A. It is also worth noting that for pores with a size of 60 nm (smaller than the size of the COVID-19), a maximum spacing of −330 nm is needed to achieve a good breathability (85 L/min). This spacing is possible using state-of-the-art lithography tools based on EUV and DUV. However, when using cheaper proximity photolithography tools, which have a resolution of −1 μm, multiple patterns of the membrane would be necessary to increase its porosity, as illustrated in FIG. 10B.

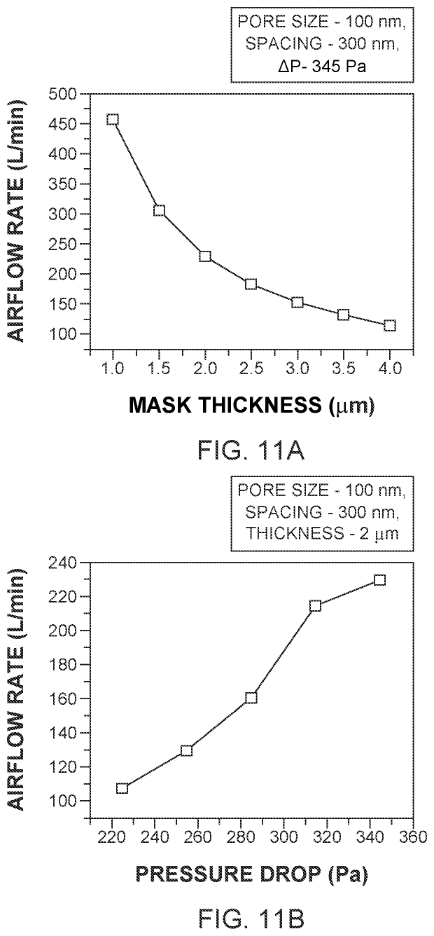

If the patterned squares 810 on the Si template 800 are 1 μm by 1 μm, then the spacing between the nanopores 202 would be larger than 1 μm. The thickness of the PI-based membrane 200 can also be customized by spin-coating it at a higher speed to achieve a thinner membrane with enhanced breathability, as illustrated in FIG. 11A. In this regard, FIG. 11A shows that the thinner the membrane 200, the larger the airflow through the membrane for a given pore size, spacing, and pressure gradient. In addition, the membrane enables breathability across a wide range of pressure drops as illustrated in FIG. 11B.

In all of these cases, an increased airflow rate does not affect the filtration efficiency if the membrane pore size is smaller than the COVID-19 size as a result of the straining mechanism. When the pore size of the membrane 200 is larger than the particle size (as in the case of an N95 mask with 300 nm pores), then an increased air flow rate has been shown to reduce the filtration efficiency.

Because the main filtration mechanism in the proposed nano-porous membrane is based on straining, in which particles that are larger than the pore dimensions are filtered out, a layer of particles would accumulate on the external surface of the membrane, blocking some pores and, therefore, reducing the airflow rate through the membrane, especially if worn for extended period of times. As a result, an antifouling mechanism would normally be needed to clean the surface of the membrane. In one embodiment, because the proposed membrane is based on PI, which is intrinsically hydrophobic (water contact angle larger than 90°), the layer of particles would naturally be rejected by the membrane. When the membrane 200 is worn on the mask 210, a large inclination angle is obtained (the membrane is almost vertical), which leads to the rolling and/or sliding off the droplets/aerosols. The rolling of the droplets on the inclined hydrophobic surfaces has been studied extensively in the past, both experimentally and using simulations, for applications in self-cleaning. As the inclination angle is increased and the droplet size is reduced, the rotational speed of the droplet increases, making the antifouling process faster. In addition, the hydrophobicity of the PI membrane might be useful in repelling water droplets, which are the carriers of the novel coronavirus. In one application, it is possible to coat the membrane with a hydrophobic material to further repel aerosol deposition.

In one embodiment, it is also possible to add a radio-frequency (RF) detector to the nano-porous membrane 200, which is the sensor 220 shown in FIG. 2A. The RF detector 220 may be used to track the mask through a given building, for example, a hospital, and to keep track of when the 8 h (or any other time) lifetime of the membrane 200 has expired. When the system that is linked to the RF detector 220 determines that the lifetime of the membrane has expired, the user of the mask is warned that he or she needs to replace the membrane 200 with another one. The RF detector 220 has a unique ID that is associated with the wearer of the mask so that the hospital knows whom to make aware of the need to replace the membrane 200.

In other embodiment, the nano-porous membrane 200 may be connected to the power source 230, which may be a small battery. The battery may be connected to the two or more terminals 232 and 234, which extend around the membrane 200. The battery may be programmed to generate a small current to the terminals, so that the membrane 200 can be electrically charged to be positive or negative. In this way, if the incoming droplets carrying the virus particles have a preponderant electrical charge, e.g., positive, the membrane 200 may be charged with the opposite charge, e.g., negative, to also electrostatically repel the incoming droplets. The embodiments discussed herein may be combined in any desired manner as will be recognized by one skilled in the art.

The above discussed embodiments describe the development of a hole making tool or Si-based nano-porous template, which are used for manufacturing a nano-porous hydrophobic membrane that can be attached to an existing N95 mask for extending the lifetime of the mask. The membrane is cheap and replaceable. Pores with sizes down to 5 nm were achieved with a narrow distribution within the membrane. The flexible membrane could also be used on a reusable N95 mask to enhance its filtering efficiency against sub-300 nm particles, including the COVID-19 virus. Moreover, the reusability of the N95 mask contributes toward relieving the challenges arising from the shortage of single-use face masks. The filtration mechanism is based on straining, with pores that are smaller than the virus particles. Theoretical calculations on the airflow rate show that the membrane is breathable over a wide range of pore sizes, densities, membrane thicknesses, and pressure drops. Multiple patterning steps can be performed on the membrane to increase its porosity and to increase the allowable airflow rate through it without affecting its filtration efficiency. In one application, the membrane is based on a naturally hydrophobic polymer which contributes to self-cleaning as a result of the rolling of the droplets on the inclined surface.

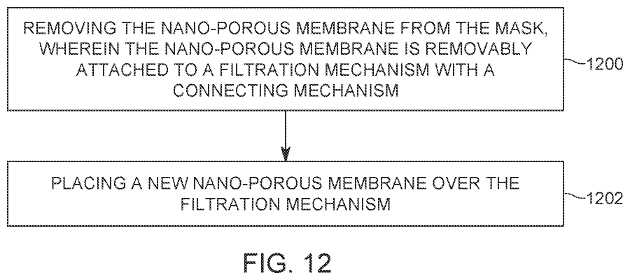

A method for replacing a nano-porous membrane 200 of a breathing mask 210 that is worn on the face is now discussed with regard to FIG. 12. The method includes a step 1200 of removing the nano-porous membrane 200 from the mask 210, wherein the nano-porous membrane 200 is removably attached to a filtration mechanism 212 with a connecting mechanism 240, and a step 1202 of placing a new nano-porous membrane 200′ over the filtration mechanism 212. The filtration mechanism 212 is configured to filter out particles having a diameter larger than a first predetermined value, and the nano-porous membrane 200 is configured to filter out particles having a diameter larger than a second predetermined value, which is different from the first predetermined value.

The disclosed embodiments provide a nano-porous membrane that can be removably attached to an existing mask to prolong the lifetime of the mask and/or to increase the filtration efficiency of the mask. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A breathing mask for being worn on the face, the breathing mask comprising:
a filtration mechanism configured to filter out particles having a diameter larger than a first predetermined value;
a connecting mechanism; and
a removable nano-porous hydrophobic membrane configured to be removably attached to the filtration mechanism with the connecting mechanism,
wherein the nano-porous membrane is configured to filter out particles having a diameter larger than a second predetermined value, which is different from the first predetermined value.

2. The mask of claim 1, wherein the first predetermined value is 300 nm and the second predetermined value is 100 nm.

3. The mask of claim 1, wherein the first predetermined value is 300 nm and the second predetermined value is 50 nm.

4. The mask of claim 1, wherein the first predetermined value is 300 nm and the second predetermined value is 5 nm.

5. The mask of claim 1, wherein the nano-porous membrane is made from silicone.

6. The mask of claim 1, wherein the nano-porous membrane is made from paper or fabric or a mesh of nanofibers.

7. The mask of claim 1, wherein the connecting mechanism includes hook-and-loop fasteners.

8. The mask of claim 1, further comprising:
a radio-frequency detector so that a usage time of the nano-porous membrane is traced.

9. The mask of claim 1, further comprising:
a power supply and a connector for charging the nano-porous membrane with positive or negative electric charges.

10. A method for replacing a nano-porous membrane of a breathing mask that is being worn on the face, the method comprising:
removing the nano-porous membrane from the mask, wherein the nano-porous membrane is removably attached to a filtration mechanism with a connecting mechanism; and
placing a new nano-porous membrane over the filtration mechanism,
wherein the filtration mechanism is configured to filter out particles having a diameter larger than a first predetermined value, and
wherein the nano-porous membrane is configured to filter out particles having a diameter larger than a second predetermined value, which is different from the first predetermined value.

11. The method of claim 10, wherein the first predetermined value is 300 nm and the second predetermined value is 50 nm.

12. A method for manufacturing a nano-porous membrane to be used with a breathing mask, the method comprising:
providing a membrane; and
making nano-holes into the membrane to obtain a nano-porous membrane, wherein the nano-porous membrane is configured to filter out particles having a diameter larger than a first predetermined value,
wherein the breathing mask has a filtration mechanism configured to filter out particles having a diameter larger than a second predetermined value, which is different from the first predetermined value.

13. The method of claim 12, wherein the first predetermined value is 100 nm and the second predetermined value is 300 nm.

14. The method of claim 12, further comprising:
shrinking the nano-holes by exposing the membrane to heat to form the nano-porous membrane.

15. The method of claim 12, wherein the nano-holes are made with a hole making device that includes nano-needles.

16. The method of claim 12, further comprising:
growing nano-needles on a substrate; and
using the nano-needles to make the nano-pores into the membrane.

17. The method of claim 12, wherein the step of making nano-holes comprises:
depositing a first polymer layer on a substrate;
placing a mesh of nanowires on the first polymer layer;
exposing the mesh of nanowires to a laser beam to pattern the first polymer layer to make nano-grooves;
removing the mesh of nanowires;
depositing a layer of Pt in the nano-groves and over the first polymer layer;
forming a second polymer layer over the layer of Pt;
removing the substrate and the first polymer layer to expose nano-needles of Pt; and
making the nano-holes into the membrane with the nano-needles of Pt.

18. The method of claim 12, wherein the step of making nano-holes comprises:
depositing a layer of silicon on insulator (SOI) over a buried insulating layer;
oxidizing a top surface of the SOI to form an oxide layer;
patterning the oxide layer to expose regions of the SOI;
etching the exposed regions of the SOI to form V-grooves;
removing the SOI from the buried insulating layer; and
sputtering a metal on top of the SOI to obtain a porous template.

19. The method of claim 18, further comprising:
depositing a polymer layer over a substrate to form the membrane;
placing the porous template over the membrane;
applying reactive ion etching through the porous template to make nano-holes into the membrane; and
removing the porous template and the substrate to obtain the nano-porous membrane.

20. The method of claim 12, further comprising:
attaching a hoop-and-loop fastener to the nano-porous membrane or to the filtration mechanism.
